(19) United States
(12) Patent Application Publication
(10) Pub. No.: US 2009/0324841 A1
(43) Pub. Date: Dec. 31, 2009

(54) METHOD OF RESTORING NEAR-WALL COOLED TURBINE COMPONENTS

(75) Inventors: Douglas J. Arrell, Oviedo, FL (US); Allister W. James, Orlando, FL (US); Anand A. Kulkarni, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 12/117,954

(22) Filed: May 9, 2008

(51) Int. Cl. B32B 43/00; B05D 1/08

(52) U.S. Cl. 427/446; 427/142

(57) ABSTRACT

A method is provided for restoring a near-wall channeled gas turbine engine component (100, 200) which has been exposed to engine operation. In a representative embodiment, a cooling channel (102) of the component (100) is filled with a polymer that solidifies to form a preform material (110) in the cooling channel (102). Then existing outer wall layers (106, 108) of the component (100) are removed, thereby exposing in part the preform material (110). New outer wall layers (106-N, 108-N) are applied over the component (100), and this may be done while a cooling flow is also applied to the component (100). Then the preform material (110) is removed without destroying the new outer wall layers (106-N, 108-N). The new outer wall layers (106-N, 108-N) may be applied by HVOF processes or by other methods.

### FIELD OF THE INVENTION

The present invention relates to combustion gas turbines, and more particularly relates to a method of restoring turbine components, such as blades, vanes, rings and heat shields, which have cooling channels formed therein.

### BACKGROUND OF THE INVENTION

Efficiency and other performance criteria are driving higher the firing temperatures of combustion gas turbines in recent years. As these firing temperatures continue to rise, so is rising the requirement to improve the cooling efficiency of the blades, vanes, and other components subjected to the heat of the combustion gases in the gas turbine (collectively, “hot gas path components”).

Current firing temperatures easily are high enough to melt the metal alloys used for the hot gas path components. As a consequence of this, many such components are cooled using a gaseous cooling fluid passed through cooling channels within the component The transfer of heat to the cooling medium, often compressed air or steam, cools the component. It is well known that some cooling is “open,” in that some or all of the cooling fluid is released through apertures in the component into the hot gas path, while other cooling is “closed,” meaning that no cooling fluid within the cooling channel system is so released.

Also, to further increase the efficiency of the cooling, a thermally insulating layer may be attached to the surfaces of the component exposed to the hot gas path or other sources of heat. The temperature gradient over this layer (one example of which is a Thermal Barrier Coating, or “TBC”) is high. This allows a reduction in the amount of cooling fluid needed in the cooling channels to attain a desired cooling effect and component temperature.

Since the strength of the metal alloy comprising a component declines as temperature rises, it is beneficial to keep the operating temperature relatively low for the metal alloy responsible for structural integrity. By designing and placing cooling channels, and thus the cooling air flow therein, close to the surface of the metal component, the parts of the component that are behind (interior to) the cooling medium in the cooling channels are kept much cooler than in various conventional designs where the metal material of the component is cooled from behind (i.e., more interiorly).

Thus, there exist gas turbine components that are designed and constructed to have near-wall cooling channels, also referred to as “four wall” cooling. For example, the more interior walls of cooling channels for such components may be formed on the outside of the casting and then one or more layers is/are applied over the case substrate to form the component's outer wall.

Repair and rebuilding of such components having near-wall cooling channels presents new challenges. As the outer surface of such components is inherently thin, with cooling channels relatively close the surface, the processing steps that are used to strip off the outer coating layer(s) during repair and/or rebuilding present a risk of penetrating the cooling channels. There is a particularly high risk of this in components in which the outer wall is completely made of bond coat material. The inadvertent penetration to the channel during these processing steps is highly deleterious as it makes restoration of the cooling system extremely difficult and costly.

In view of the above, there remains a need in the art for a method of repairing and rebuilding a gas turbine component comprising cooling channels near the outer surface of the component.

### BRIEF DESCRIPTION OF THE DRAWINGS

The invention is explained in the following description in view of the drawings that show:

FIGS. 1A-1F provide cross-sectional simplified schematic depictions of a portion of a gas turbine component in different stages of restoration, starting with the component in need of such repair or rebuild.

FIG. 2 is a perspective view of a gas turbine engine near-walled blade assembly 240 that has been in use in a gas turbine engine and is a candidate for restoring.

FIG. 3 is a schematic view of the application of a coating onto a surface of a component being restored, two alternative approaches are shown for cooling the component during the application of the coating.

FIG. 4 is a schematic diagram of a gas turbine engine that may comprise components made by the method of the present invention.

### DETAILED DESCRIPTION OF EMBODIMENTS OF THE INVENTION

The present invention relates to a method of restoring to a useful operational condition a gas turbine engine component that has been in use during operation of a gas turbine engine. Such a component is referred to herein as an “engine-run gas turbine engine component.” More particularly, the present invention is directed to restoring an engine-run gas turbine engine component that comprises near-wall cooling channels, also referred to as “four wall” cooling. One example of such a near-wall cooled component is a gas turbine blade in which cooling channels were formed in the metallic substrate, filled with a preform material to establish a channel volume, and over which a bond coat and thermal protective coating were applied (the preform material thereafter being removed by ways known in the art). In such a near-wall component, there is no metallic substrate material forming the most exterior wall portions of cooling channels. More generally, the most exterior wall portions of the cooling channels may be formed by applying layer(s) of one or more of a sprayed metal and/or a bond coat and thermally insulating layer (such as a thermal barrier coating (“TBC”). These collectively are considered the outer wall of such component. As stated above, since the outer surface of such components is inherently thin, with cooling channels relatively close to the surface, the processing steps that are used to strip off any of these outer layer(s) during a restoration method present a risk of penetrating the cooling channels.

It is noted that the terms “restore” and “restoring” are taken to include repairing and rebuilding as those terms are used in some instances in the art. As used infra in the present disclosure, “repair” is taken to mean a specific corrective procedure to an identified structural defect rather than the overall procedure to bring an engine-run gas turbine engine component back to a condition for re-use in a gas turbine engine.

The present method includes the step of filling, such as by injecting into the cooling channels a material that has the properties of being flowable during injection, settable, and removable by ways not destructive of the component itself. This is referred to herein as a ‘preform material’ which may be selected from resins, waxes and polymeric materials, including high temperature plastics and high temperature waxes. One type of preform material, not to be limiting, is a polytetrafluoroethylene (PTFE)-based polymer. An alternative melting point performance criterion for such preform material is that the preform material does not melt until the ambient temperature is at least 300° C. As described in detail, infra, the present method may also include an optional step of filling venting passage that extend from the cooling channels through the outer wall that is to be restored to an exterior surface.

After the preform material has cooled in the cooling channels and has set to a solid that defines the volumes of the cooling channels, the existing outer wall layers are removed. Not to be limiting, one way to effectuate such removal is by fluoride-ion cleaning. Depending on the layers originally applied and the level of wear during operation of the component, such outer layers being removed may include only the bond coat (or portions thereof), or the bond coat (or portions thereof) and at least a portion of a more external thermally insulating layer such as a TBC. In various embodiments this removal step exposes a portion of the preform material, such as that which defines the most exterior wall portions of a channel. However, even after this process the preform material sufficiently defines the volumes of the cooling channels for future operational purposes.

An optional step (but one common when using high velocity oxy-fuel spraying (HVOF process step) and other thermal spray processes) is to cool the target component. This cooling may be done by any of various ways known to those skilled in the art.

A subsequent step is the spraying of the layers of the component's new outer wall over the component substrate with its added preform material. This may be multiple layers that include a bond coat and a TBC, or may also include layer(s) of sprayed metal. The first layer of the outer wall contacts the substrate surface of the component as well as portions of the preform material that are exposed. The outer wall may be formed by high velocity oxy-fuel spraying process (HVOF process step) or other layer forming systems as these may be selected in various embodiments of the method for particular components.

After the outer wall is applied, the component is heated or otherwise treated to remove the preform material. This is done without destroying the outer wall layers, which may include bond coat and thermal barrier coating layers in various embodiments. The component now is ready for inspection after restoration and for re-use in a gas turbine engine.

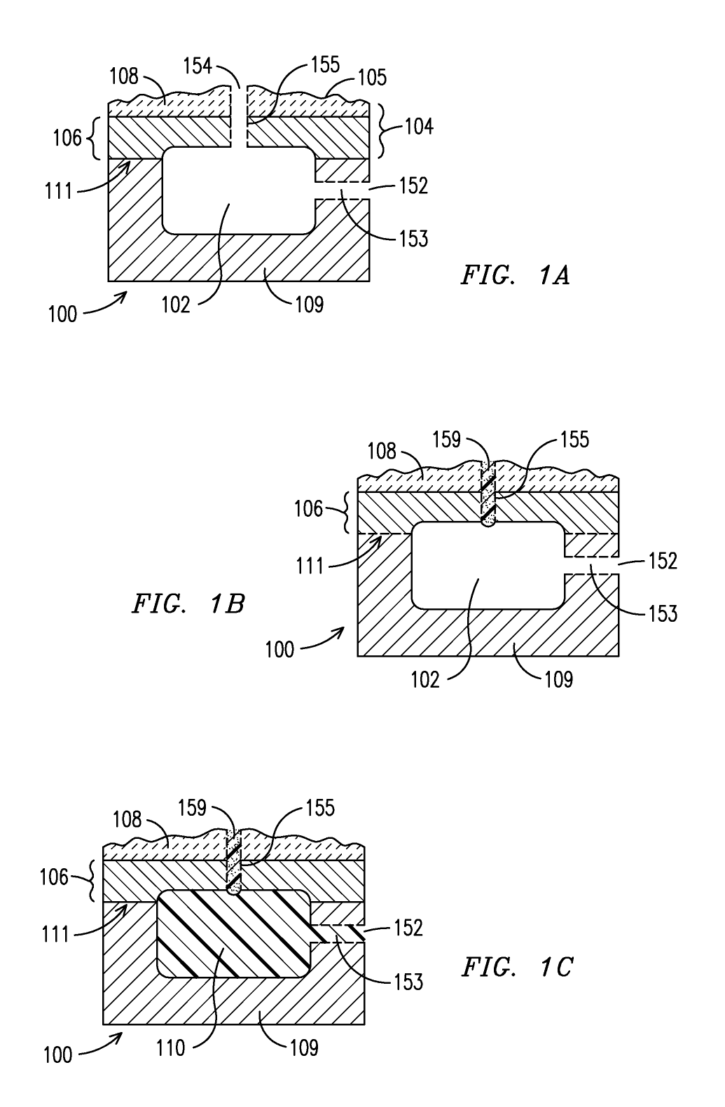

Having generally described the method, the following more detailed discussion is directed to restoring an engine-run gas turbine engine blade. FIGS. 1A-1E depict various stages of the procedure by providing schematic cross-sectional views of a portion of a turbine engine blade 100. FIG. 1A depicts a portion of an engine run gas turbine engine blade 100 comprising a cooling channel 102 and a worn-down outer wall 104 having an exterior surface 105 and comprising bond coat layers 106 and portions of a thermal barrier coating 108 (individual layers not shown, see FIG. 1D). This blade 100 is in need of restoration. A substrate 109, such as of a high-performance metal alloy, provides the basic structure of the blade 100 and is shown in part below the bond coat layers 106. An outer surface 111 of the substrate 109 is shown to contact the innermost of the bond coat layers 106.

As will be apparent to one skilled in the art, the first steps of preparing the blade 100 include removing detachable details and other similar parts as appropriate (not shown). Other preliminary steps may include light dust blasting of the blade, thorough cleaning to remove dust or other channel blocking materials (such as by ultrasonic cleaning and/or high pressure cleaning), and visual inspection.

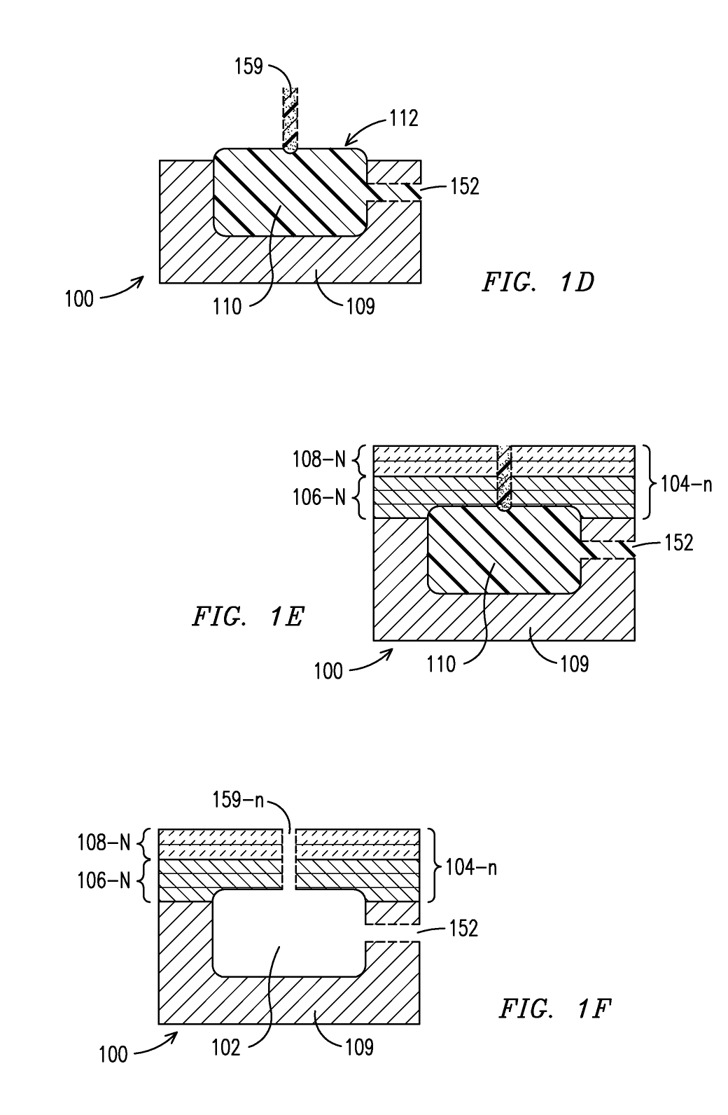

To represent a trailing edge aperture, an optional trailing edge aperture 152 is depicted in FIG. 1A; this optional aperture 152 connects to cooling channel 102 via a passage 153 depicted with dashed lines to indicate it is optional. Such apertures and passages are further discussed during discussion of FIG. 2 below. The optional trailing edge aperture 152 typically remains internal to the substrate of the component and the passage 153 does not pass through the outer wall layers of a thermal barrier coating system (TBC is generally not applied at the trailing edge when ejection cooling holes are present). As described herein, the passage 153 allows for venting of the cooling channel 102 during filling of the latter with a polymer during the method of the present invention.

Also, a plurality of optional venting passages such as venting passage (film cooling holes) 155 may be provided, each having an external hole such as external hole 154. Venting passage 155 is shown to extend from the cooling channel 102 to the exterior surface 105 of the blade 100. In various embodiments of the method these venting passages, such as venting passage (shower head and film cooling holes) 155, are filled with a ‘venting passage material’ such as with a resin. Filling may occur through the external hole 154. It is noted that the layers of the outer wall 104 adjacent each optional external hole 154 is least likely to become degraded since the cooling effect of the cooling fluid through the optional venting passage (shower head & film cooling holes) 155 and out the optional external hole 154 works to reduce heat-related degradation. Thus, the position of the external hole 154 of the venting passage 155 is located relatively close to a position of the new or restored venting passage's hole (see FIG. 1F).

The reason for filling the venting passages such as 155 with a suitable venting passage material is to preserve these passages during the restoring method. Otherwise these venting passages would be lost, leading to extensive reboring, etc. The venting passage 155 may be filled with a suitable venting passage material, such as a resin, by injecting the venting passage material through the respective external hole 154, such as with a hypodermic syringe. Alternatively, the venting passage material may be pushed into a plurality of such holes, such as with a putty knife, squeegee, etc., when the venting passage material being used has a paste-like consistency, followed by smoothing the surface to remove excess material.

FIG. 1B shows venting passage 155 filled with a venting passage material 159. It is noted that a small portion of this venting passage material 159 may extend, as shown in FIG. 1B, slightly into the space of cooling channel 102. In various embodiments, the filling step is effective to fill at least the entire venting passage 155.

After any such preliminary steps, which are optional (such as for a component lacking such venting passages), a PTFE-based polymer is injected via the blade root main cooling channel (not shown, see FIG. 2 and related discussion). The polymer moves under pressure through an internal cooling system that extends from the blade root to all cooling channels, including those superficial cooling channels such as 102 that are near the outer wall 104 of the blade 100. The cooling channel (102 in FIGS. 1A and 1B) now filled in with preform material 110 is depicted in FIG. 1C. When optional apertures such as a trailing edge aperture 152 exist (see also FIG. 2), the polymer may exit these apertures 152, which have not been previously plugged with resin, and the polymer plugs them also. While not meant to be limiting, such approach allows for venting of air from the cooling channels 102. Excess polymer (not shown) that extends from the apertures 152 may be removed by a knife or other tool or other means prior to the next step. After the polymer comprising the preform material 110 has cooled, removal of the outer wall 104's external layers may proceed.

In cases where no such optional apertures exist, or where complete filling would otherwise not be possible, other means may be used to provide for complete filling of the channels with preform material. For example, a vent hole may be formed just for the purpose of releasing air as the preform material is added at an opposite end of the channel system, or a vacuum could be drawn in the channel system and then the preform material added.

When at least a portion of a ceramic-based thermal protective coating, such as a TBC, remains on the engine-run blade, this is removed by means known in the art, such as chemical treatments (e.g., soaking in KOH) or by abrasive procedures, such as grit blasting, vapor honing, and glass bead peening. If the method used is chemical, a subsequent chemical treatment for the bond coat may be soaking in acidic solutions such as phosphoric/nitric mixtures. The bond coat, which may be a McrAlY type, is thus removed. The blade 100 after removal of the bond coat layers 106 and portions of the thermal barrier coating 108 is shown in FIG. 1D. It is noted that due to the characteristics of the venting passage material 159, this retains it shape during and after the removal of these outer wall layers.

The blade 100 in this condition may then be heat tinted to verify removal of the bond coat. Also, the blade 100 may be inspected with techniques that include, but are not limited to, visual inspection, fluorescent penetrant inspection (FPI), x-ray inspection or any other appropriate method known to one skilled in the art to determine the presence of cracks and internal wall defects. The inspection criteria will depend on the particular blade being restored. Some blades will not have the required minimum thickness, rendering the blade unsuitable for restoration, although small repairs by a technique such as welding or brazing may be appropriate to extend its useful life.

After the blade 100 as shown in FIG. 1D has been inspected, it may be necessary to repair the blade to remove any undesirable cracks by welding, blending, or other similar methods. Recontouring by welding or brazing can be done as well. Recontouring of the welded material can be carried out by the electro-discharge machining (EDM) process. The repair is carried out wherever it may be needed on the blade. If channels are affected by a repair that may include recontouring, these channels may also need restructuring and filling with a preform material to maintain the desired channel shape. In some embodiments, where feasible, any needed repairs and restructuring is done prior to the injection of the preform material.

With the blade 100 in condition for deposition of new outer layers to form a new outer wall, having at least a portion 112 of the channel-filling preform material 110 exposed after removal of the old layers (see FIG. 1D), a MCrAlY bond coating is reapplied to the entire blade. FIG. 1E depicts the deposition of various newly applied layers of such bond coat 106-N. In this embodiment, the McrAlY bond coating then is subjected to diffusion and aging heat treatment.

The new bond coat 106-N may be deposited by any method known in the art, for example by a spraying process. When a spraying process is used, the spraying process may be any thermal spray process which does not significantly heat the preform material (110) and/or the venting passage material (159) so as to cause melting and/or deformation under the method conditions. Examples of thermal spray processes may include air plasma spraying (APS), low pressure plasma spraying (LPPS), vacuum plasma spraying (VPS), twin wire arc spraying, and high velocity oxy-fuel process (HVOF). This (particularly when a cooling step is used) allows relatively low melting temperature materials to be used for the preform and venting passage materials.

Thus, more generally, in various embodiments the newly applied bond coat 106-N may be applied by one or more spraying processes, which may include air and vacuum plasma spray processes.

It is noted that molten metal typically has temperatures between about 1,800 and 3,000° C. When such molten metal is being applied, such as by HVOF process, it may heat the component to a temperature between about 400 to 700° C. Thus, in various embodiments, a step is pre-cooling the target component to be coated so that the surface of the target component (i.e., blade) is less than or equal to 300° C. Thus, for example, when the preform material and the venting passage material have sufficiently elevated melting points in relation to the temperature of the layer(s) being applied (whether molten metal as sprayed metal or sprayed bond coat, or as a thermally insulating layer), the preform material and the venting passage material effectively maintain their respective desired shapes and features. Alternatively, or in combination with pre-cooling, applying a coating may be conducted simultaneously with cooling the component, such as so as to maintain the surface of target component at less than or equal to 300° C.

The newly applied bond coat 106-N should be applied to the blade in a thickness to provide a strong bond between the blade and ceramic topcoat and to prevent cracks that develop in the ceramic topcoat from propagating into the blade and to provide oxidation resistance. Preferably, the bond coat 106-N will be applied in a thickness between about 50-400 μm. In some situations where there has been strong oxidation of the blade or the tip has become too thin, a thicker MCrAlY layer may have to be applied. In such a situation a bond coat 106 of between about 200-500 μm should be used.

In various embodiments such as the above example the bond coat is an MCrAlY, wherein the “M” stands for Fe, Ni, Co, or mixture of Ni and Co. As used in the present invention, the term MCrAlY also encompasses compositions that include additional elements or combinations of elements such as Si, Hf, Ta, Re or noble metals known to those skilled in the art. The MCrAlY may also include a layer of diffusional aluminide, particularly an aluminide that comprises one or more noble metals. In various embodiments the bond coat comprises about 30-34% Nickel, 19-23% Chromium, 6-10% Aluminum, 0.2-0.7% Yttrium, with the balance Cobalt.

Following heat treatment of the bond coat 106-N, a thermal barrier coating 108-N is applied over the bond coat 106-N. FIG. 1E depicts layers of the thermal barrier coating 108-N by showing dashed lines to delineate adjacent layers. In various embodiments this may be a non-abradable thermal barrier coating. As used herein, the term “non-abradable” refers to a thermal barrier coating with porosity in the range of 5-15% and composition having small amounts of various oxides present in the coating mixture. For example, in some embodiments the thermal barrier coating 108-N thus may comprise a mixture of partially stabilized zirconia, which is a mixture of zirconium oxide (ZrO2) and a stabilizer such as yttrium oxide (Y₂O₃) and lesser amounts of hafnium oxide (HfO₂), magnesium oxide (MgO) and calcium oxide (CaO) or mixtures thereof. Yttrium oxide is a preferred stabilizer for a number of embodiments. In various embodiments the thermal barrier coating comprises about 90-96% ZrO2, about 4-10% Y₂O₃, about 2.0% or less of HfO₂, about 0.2% or less of MgO and CaO each, about 0% TiO₂, about 0.05% or less of U+Th, about 0.13% or less of Al₂O₃, and about 0.1% or less of Fe₂O₃.

For most applications, the thermal barrier coating 108-N is between about 150-500 μm in thickness. The thermal barrier coating of the present invention is deposited using methods known to those skilled in the art, such as those listed above for the application of the bond coat layers.

Burnout heat treatment, or other method to remove the preform material 110 and the venting passage material 159, follows application of the TBC. This treatment is effective to remove the preform material and the venting passage material 159 without destroying the overlying outer wall layers. The portion of the blade 100 after removal of the perform material 110 and the venting passage material 159 is shown in FIG. 1F. It is noted that the thickness of the new outer wall 104-N may be greater than the thickness of the outer wall 104 shown in FIG. 1A.

Also, overspray grinding and surface grinding (hand grinding or blasting/tumbling (preferred) may be required to complete the restoration process, followed by final inspection and quality-relevant measurements such as airflow, roughness, moment weigh, coating weight, coating thickness, and the like.

A specific example based on the above disclosure and features of FIG. 2 follows.

FIG. 2 provides a perspective view of a gas turbine engine near-walled blade assembly 240 comprising a blade root 242 connecting with an elongate blade airfoil 244 at a blade platform 248. The blade assembly 240 has been in use in a gas turbine engine and is a candidate for restoring. Along the surface of the blade airfoil 244 are cooling holes 250 that may be clearly distinguished from the trailing edge apertures 252.

For Example 1 and other embodiments of the present method, the venting passages 155 (see FIG. 1A-C), terminating in FIG. 2 as cooling holes 250, may be plugged with a resin or other material selected from various brands of resin materials, such as the Ceramabond® 571 Magnesium adhesive (Aremco Products, Inc., Valley Cottage, N.Y. USA) and Pyro-Putty™ 1000 Paste (Aremco Products, Inc., Valley Cottage, N.Y. USA);

These resins and other materials confer an advantage, namely that when certain bond coat or other sprayed metal materials, such as NiCoCrAlY, CoNiCrAlY based bond coats, alloy compositions of Alloy (CM)247LC, H230 and FeCrAlY based materials, are applied over them, these bond coat or other sprayed metal materials do not adhere to the resin or other material that is plugging the cooling hole 250. Consequently, after application of the outer layers of bond coat and TBC, the resin or other material, such as those listed above, that are filling the cooling holes 250 remains exposed. After the removal of the resin or other material (such as by heating in Example 1), the holes are visible and as needed may be bored out to remove any bond coat that may encroach to have narrowed the specification hole diameter. The trailing edge apertures 252, which may be the most downstream exits of the cooling channels (inside the blade airfoil 244 and not shown) become filled with the material, such as polymer, that forms the preform material within the channels. Similar boring may be done as needed for the trailing edge apertures 252.

### EXAMPLE 1

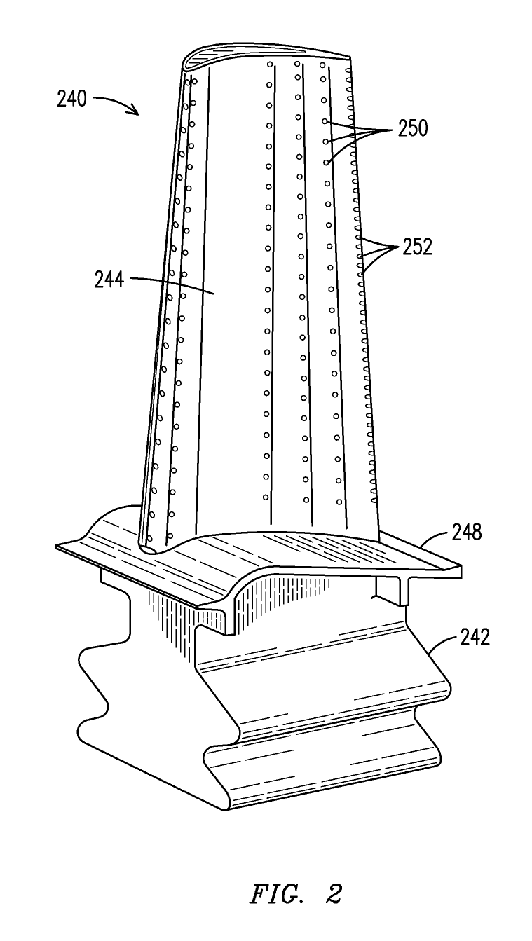

As noted above, FIG. 2 provides a more representational depiction of a gas turbine engine near-walled blade assembly 240 and may be referred to for this Example. Blade assembly 240, which has been used in an operating gas turbine engine (not shown, see FIG. 3 and its discussion) is removed from that engine for restoration. The blade airfoil 244, which was exposed to a hot gas path, was originally coated with a NiCoCrAlY bond coat and a thermal barrier coating comprised of 8YSZ. After inspection and analysis confirming it is suitable for restoration, the following steps are conducted.

First, cooling holes 250 leading to the exterior surface of the blade (other than the apertures 252 of the trailing edge) are filled with resin (see FIG. 1B). Then a PTFE-based polymer is injected via the blade root cooling channel (not shown in this view, arrow indicates location). The polymer fills the cooling channels (see FIG. 1C) and extrudes out the trailing edge apertures 252 (see FIG. 1C). Once the polymer has cooled, the component is fluoride-ion cleaned to strip off the bond coat down to the cooling channels (see FIG. 1D above). The blade is then re-sprayed using HVOF to restore the NiCoCrAlY bond coat and the 8YSZ thermal barrier coating (see FIG. 1E above).

After deposition of these layers, the blade is heated to 600° Celsius in air and held at that temperature for 2 hours. This oxidizes and burns off the preform material (see FIG. 1F) without destroying the bond coat and thermal barrier coating. The cooling channels are then high pressure water cleaned to ensure that the preform material has been completely removed.

Generally, a clear advantage of this approach to restoration is that specific features of the channel walls are maintained in the restored component. These features are maintained because the preform material injected into the cooling channels conforms to these features and the layers applied over the preform material exposed portions effectively reform these features as part of the reformed outer portions of the walls. This is particularly relevant when the component was originally manufactured with features in the channel walls such as turbulators that enhance cooling efficiency such as by imparting cooling channel contours providing a desired flow pattern. Turbulators are known in the art, such as in U.S. Pat. No. 6,641,362, which is incorporated by reference for its teachings of turbulators. More generally, as used herein, a “turbulator” is any physical feature that causes turbulence to a fluid flow and so increases heat transfer, and without being limiting includes what is known in the art as a trip strip, a dimple, and a pin fin. By injecting a material for form the preform material, such features are maintained in a restored component, so that the performance of the restored component is comparable to that of the new component. This is considered important especially when dealing with restoration of near-wall engine-run gas turbine engine components.

Any of a range of hot-gas path components for a gas turbine engine may be made with the method described herein. Without being limiting, these include vanes, rings and segments, annular combustors, combustor cans and transition ducts. Such components, restored per the above method, are then placed into use in a gas turbine and may exhibit cooling properties comparable to the original components.

FIG. 3 is a schematic view of the applying of a coating 370 onto a surface 311 of a component 300 being restored, showing two alternative approaches to cooling the component during the applying. One approach is to provide jets 372 on a spray head 374 that comprises a nozzle 375 emitting a spray 376 of molten or otherwise heated material on the surface 311 to form the coating 370 (arrow indicates motion of spray head 374). The jets 372 provide a flow of cooling fluid 378 that cools areas of the surface 311 adjacent (or including when so angled) a region 380 where the spray 376 contacts the surface 311. This provides a cooling of the surface 311 and the component 300, thereby keeping the preform material (110, not shown, see FIG. 1A-F)) and/or the venting passage material (159, not shown, see FIG. 1A-F) from melting and/or deformation under the method conditions. It is appreciated that one or more such jets 372 may be provided in a particular spray head 374. An alterative approach (which may, if desired, be conducted concurrently with the first approach), is to cool by providing a lateral cross-flow tangentially to the surface 311. For example, a cooling flow source 382 (for example comprising a plurality of air jets 384) may be positioned at 45 or 60 degrees from the plane of the surface 311. This cooling flow source 382 may be effective to provide a sufficient cooling flow to keep the preform material (110, not shown, see FIG. 1A-F)) and/or the venting passage material (159, not shown, see FIG. 1A-F) from melting and/or deformation under the method conditions. Thus, more generally, at least one cooling flow source, such as the exemplified cooling flow source 382, may be disposed to direct a cooling flow across a surface of the component being coated during said applying.

Cooling the component 300 such as by these approaches may be done while applying at least one of the new bond coat and the new thermal barrier coating, or more generally any coating over the substrate 300.

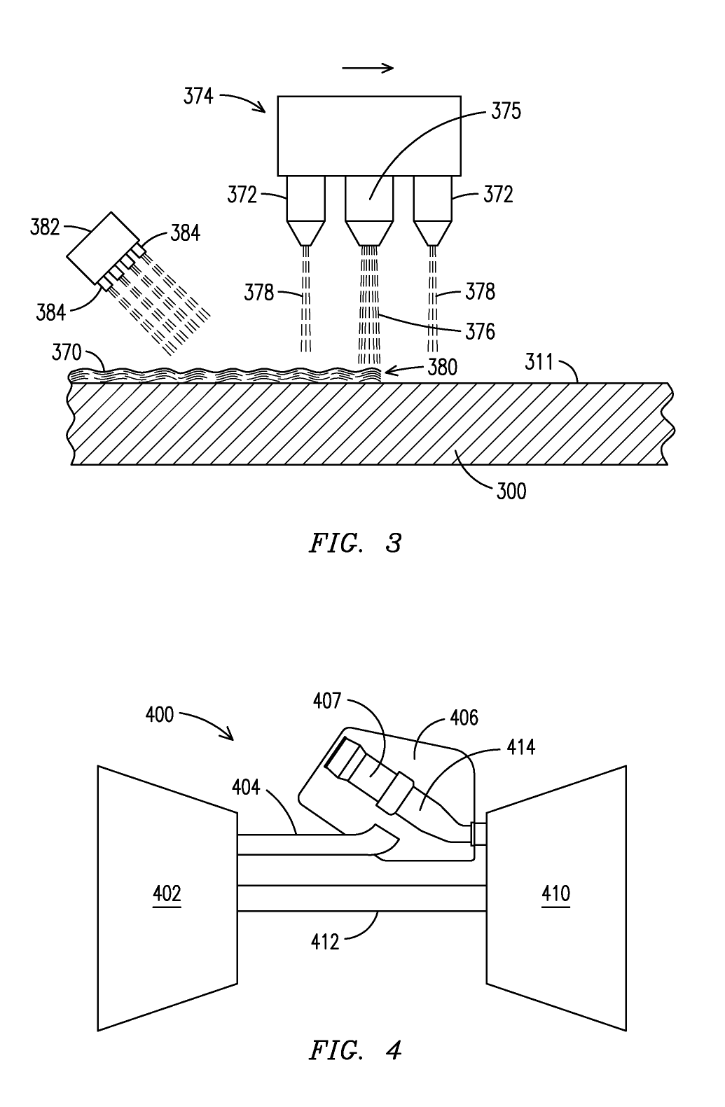

FIG. 4 provides a schematic cross-sectional depiction of a gas turbine engine 400 that comprises one or more components made by the method of the present invention. The gas turbine engine 400 comprises a compressor 402, a combustor 407, and a turbine 410. During operation, in axial flow series, the compressor 402 takes in air and provides compressed air to a diffuser 404, which passes the compressed air to a plenum 406 through which the compressed air passes to the combustor 407, which mixes the compressed air with fuel in a pilot burner and surrounding main swirler assemblies (not shown), after which combustion occurs in a more downstream combustion chamber of the combustor 407. Further downstream combusted gases are passed via a transition 414 to the turbine 410, which may be coupled to a generator to generate electricity. A shaft 412 is shown connecting the turbine to drive the compressor 402. In addition to turbine blade, placed in the turbine 410, the method may be used to produce vanes, rings, and heat shields in such gas turbine engine 400, which each comprises at least two interconnected layers of cooling channels.

It is noted that the superficial channels disclosed above may be formed by any method known to those skilled in the art. For example, not to be limiting, U.S. Pat. No. 5,875,549, issued Mar. 2, 1999 to McKinley, teaches one approach to producing numerous small passages within a component. This and all other patents, patent applications and other references cited herein are incorporated by reference into the present application for their respective teachings.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method for restoring a coated component, which has been exposed to engine operation, comprising:
providing an engine run component including a base metal substrate made of a nickel-based alloy having superficial outer cooling channels partly defined by an outer wall comprising outer wall layers of a thermal barrier coating system, the thermal barrier coating system comprising a diffusion bond coat on the base metal substrate and a top ceramic thermal barrier coating;
injecting a polymeric preform material effective to fill the outer cooling channels;
removing the outer wall layers of the component, exposing in part the preform material filling the outer cooling channels;
applying a new bond coat to the component in one or more layers, wherein the new bond coat covers at least part of the exposed preform material without deforming it;
applying a new thermal barrier coating over the new bond coat; and
removing the preform material without destroying the new bond coat and the new thermal barrier coating.

2. The method of claim 1 additionally comprising plugging a venting passage in the engine run component with a venting passage material prior to removing the outer wall layers, and removing the venting passage material when removing the preform material.

3. The method of claim 2 additionally comprising pre-cooling the component prior to applying the at least one of the new bond coat and the new thermal barrier coating.

4. The method of claim 1 wherein the preform material in the cooling channels retains the shape(s) of tubulators so as to provide cooling channel contours providing a desired flow pattern.

5. The method of claim 1, wherein the preform material provides a desired degree of roughness in an interior surface of at least one of the outer channels, effective to provide a non-laminar flow of fluids there through.

6. The method of claim 1 wherein the applying comprises a high velocity oxy-fuel spraying process.

7. The method of claim 6, additionally comprising selecting a preform material having a melting temperature of at least 300° C., effective to withstand the applying.

8. The method of claim 1, additionally comprising cooling the component while applying at least one of the new bond coat and the new thermal barrier coating.

9. The method of claim 8, wherein the cooling is provided from one or more air jets disposed on a spray gun used for applying the new bond coat.

10. The method of claim 8, wherein the cooling is provided from at least one cooling flow source disposed to direct a cooling flow across a surface of the component being coated during said applying.

11. A method for restoring a near-wall cooled component which has been exposed to engine operation, comprising the steps:
providing an engine run near-wall cooled component comprising a metal substrate having an internal cooling system including superficial cooling channels partly defined by an outer wall comprising outer wall layers applied over the substrate;
filling the internal cooling system with a preform material effective to fill the superficial cooling channels;
removing the outer wall layers of the component, exposing in part the preform material filling the superficial cooling channels and a surface of the substrate;
applying at least one new outer layer to form a new outer wall; and
removing the preform material without destroying the new outer wall.

12. The method of claim 11, additionally comprising plugging a venting passage in the engine run near-wall cooled component with a venting passage material prior to removing the outer wall layers, and removing the venting passage material when removing the preform material.

13. The method of claim 11 additionally comprising pre-cooling the component prior to applying the at least one outer layer.

14. The method of claim 11 wherein the preform material in the superficial cooling channels retains the shape(s) of tubulators or trip-strips so as to provide cooling channel contours providing a desired flow pattern.

15. The method of claim 11, wherein the preform material provides a desired degree of roughness in an interior surface of at least one of the superficial channels, effective to provide a non-laminar flow of fluids there through.

16. The method of claim 11, wherein the applying comprises a high velocity oxy-fuel spraying process.

17. The method of claim 11, additionally comprising cooling the component while applying the at least one new outer layer to form the new outer wall.

18. The method of claim 11, wherein the cooling is provided from one or more air jets disposed on a spray gun used for applying the at least one new outer layer.

19. The method of claim 11, wherein the cooling is provided from at least one cooling flow source disposed to direct a cooling flow across a surface of the component being coated during said applying.

20. A method for restoring a near-wall cooled component of a gas turbine engine, which has been exposed to engine operation, comprising:
filling cooling channels of the component with a polymeric preform material;
removing existing outer wall layers of the component, exposing in part the preform material;
applying new outer wail layers over the component; and
removing the preform material without destroying the new outer wall layers.
